(19) United States
(12) Patent Application Publication
(10) Pub. No.: US 2013/0231962 A1
(43) Pub. Date: Sep. 5, 2013

(54) SYSTEM AND METHOD FOR FINANCIAL INTERACTIVE MANAGEMENT

(71) Applicant: SU-CC CORPORATION LIMITED, Yuen Long (HK)

(72) Inventor: Suk Yee AU LI, Kowloon (HK)

(73) Assignee: SU-CC CORPORATION LIMITED, Yuen Long (HK)

(21) Appl. No.: 13/778,966

(22) Filed: Feb. 27, 2013

Related U.S. Application Data
(60) Provisional application No. 61/605,463, filed on Mar. 1, 2012.

(51) Int. Cl. G06Q 40/02; G06Q 40/08; G06Q 40/00

(52) U.S. Cl. CPC G06Q 40/025; G06Q 40/08; G06Q 40/10
USPC 705/4; 705/38; 705/30

(57) ABSTRACT

Some embodiments hereby disclosed relate to a system for loan approvals for applicants in a supply chain, and a method to operate the same. Some embodiment hereby disclosed relate to a system for insurance approvals for applicants in a supply chain, and a method to operate the same. Some embodiments hereby disclosed relate to a system for supply chain management for applicants in a supply chain, and a method to operate the same.

### FIELD

The embodiments hereby disclosed relate generally to a system for financial management, and a method to operate the same, and more specifically, a system for financial interactive management used by parties in a supply chain, and a method to operate the same.

### BACKGROUND

A supply chain is widely adopted in currently marketplace to move a product from supplier to customer. Depending on the sophistication of the product manufacturing process, several parties including buyers and suppliers may be involved in a supply chain for the procurement of certain goods or products. Usually only one supplier (the top level supplier) contracts with a buyer to obtain a purchase order for certain goods or products. Subsequently the top level supplier usually contracts with another supplier or several suppliers for part of or the entire fulfillment of the purchase order.

Financial services providers (financial institutions) in general provide financings (loans) to their clients in the marketplace including buyers and suppliers in a supply chain, to facilitate working capital flows within the supply chain. A Supplier in the supplier chain in general highly relies on financings provided by its individual financial institutions to get access to working capital in conducting its operations and productions. A smaller supplier, often a lower level supplier, may especially rely on financing for its operations and productions when attempting to accept and fulfill a substantial part of a purchase order with a high purchase price, because the smaller supplier may not be able to generate enough cash flow in its ordinary business to compensate its production overhead in the supply chain transaction. Financial service providers, on the hand, are highly regulated and look for their maximization of return of capital while controlling their overall asset riskiness below the thresholds set by laws and regulations.

Insurance providers in general provide insurances to their clients in the marketplace including buyers and suppliers in a supply chain to hedge risks associated with the product procurement processes. A supplier in the supplier chain may be required to provide a proof of insurance when applying for financings from its financial institution if the overall transaction is considered risky by the financial institution. A smaller supplier, often a lower level supplier may always be required to provide proofs of insurance when applying for financings from its financial institution because the smaller supplier may have a higher level of riskiness and a lower level of creditworthiness. At the same time the insurance provider may require higher insurance premiums from the smaller supplier because the smaller supplier may have a higher level of riskiness and a lower level of creditworthiness. The insurance premiums may in turn build into the smaller supplier's operation overhead in the supply chain transaction, raising its costs and lowering its returns in doing businesses in the supply chain. Insurance providers, on the hand, are highly regulated and look for their maximization of return of reserves while controlling their overall asset riskiness below the thresholds set by laws and regulations.

In a supply chain in general there is substantial amount of information generated and circulated among relevant parties. A massive amount of information containing obsolete or incorrect information may cause confusions, mistakes and delays in the production process, therefore lowering the efficiency of the supply chain and causing unnecessary costs for the parties in the supply chain.

### SUMMARY

The embodiments hereby disclosed relate generally to a system for financial management, and a method to operate the same, and more specifically, a system for financial interactive management used by users in a supply chain, and a method to operate the same. More specifically, some embodiments hereby disclosed relate to a system for loan approvals for applicants in a supply chain, and a method to operate the same. Some embodiment hereby disclosed relate to a system for insurance approvals for applicants in a supply chain, and a method to operate the same. Some embodiments hereby disclosed relate to a system for supply chain management for applicants in a supply chain, and a method to operate the same.

### BRIEF DESCRIPTION OF THE DRAWINGS

The following is a brief explanation of embodiments herein using drawings and embodiments:

FIG. 1 is a block diagram of a financial interactive management system.

FIG. 2 is a block diagram of a loan approval system.

FIG. 3 is a flow chart representing the steps of the loan approval system for a loan approval.

FIG. 3A is a flow chart representing the steps of an embodiment of the loan approval system in FIG. 3.

FIG. 4 is a block diagram of a loan approval and guarantee system.

FIG. 5 is a flow chart representing the steps of the loan approval and guarantee system for a guaranteed loan approval.

FIG. 5A is a flow chart representing the steps of an embodiment of the loan approval and guarantee system in FIG. 5.

FIG. 6 is a block diagram of an insurance underwriting approval system.

FIG. 7 is a flow chart representing the steps of the insurance underwriting approval system for an insurance approval.

FIG. 7A is a flow chart representing the steps of an embodiment of the insurance underwriting approval system in FIG. 7.

FIG. 8 is a block diagram of a supply chain management system.

FIG. 9 is a flow chart representing the steps of the supply chain management system for managing a supply chain.

FIG. 9A is a flow chart representing the steps of an embodiment of the supply chain management system in FIG. 9.

### DETAILED DESCRIPTION

Embodiments herein disclosed describe a financial interactive management system, and a method to operate the financial interactive management system.

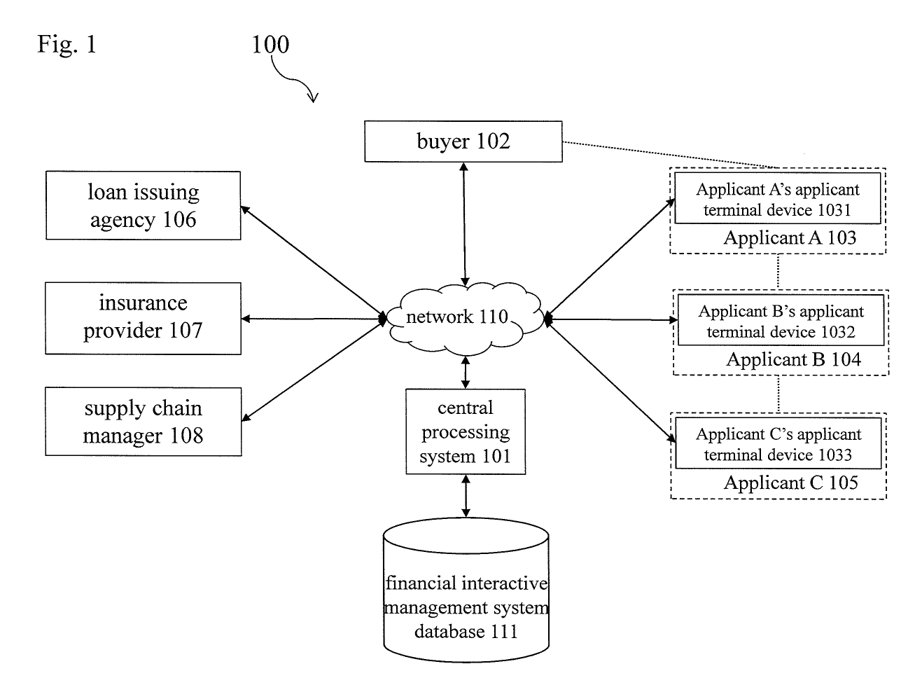

As shown in FIG. 1, in one embodiment the financial interactive management system 100 has a central processing system 101 which is configured to interact with multiple parties in a supply chain transaction.

The central processing system 101 may be configured to interact with several applicants in a supply chain including Applicant A 103, Applicant B 104, and Applicant C 105. In one embodiment the central processing system 101 may interact with applicants' terminal devices 1031, 1032, 1033. The applicants' terminal devices may be used for inputting information and for outputting or displaying information for the applicants 103, 104, 105. In one embodiment the central processing system 101 may interact with Applicants A, B and C 103, 104, 105 using a network 110. In one embodiment the network 110 may be a wired or a wireless network, or any network compatible for the purposes of interactions and communications.

In one embodiment the central processing system 101 may also be configured to interact with a buyer 102. In one embodiment the central processing system 101 may interact with the buyer 102 using the network 110.

In one embodiment the central processing system 101 may also be configured to interact with a loan issuing agency 106, e.g. a bank. In one embodiment the central processing system 101 may interact with the loan issuing agency 106 using the network 110.

In one embodiment the central processing system 101 may also be configured to interact with an insurance provider 107, e.g. an insurance company. In one embodiment the central processing system 101 may interact with the insurance provider 107 using the network 110.

In one embodiment the central processing system 101 may also be configured to interact with a supply chain manager 108, e.g. an e-commerce portal operator. In one embodiment the central processing system 101 may interact with the supply chain manager 108 using the network 110.

The central processing system 101 may further include a financial interactive management system database 111. In one embodiment the financial interactive management system database 111 may use standardized or customarily data structures and database management systems to better interact with the central processing system 101. The financial interactive management system database 111 may store data and information related to the operation of the financial interactive management system 100 and its components on traditional or specialized storage medium to perform its data storage functions. The central processing system 101 may access and update the data in the financial interactive management system database 111. In one embodiment the access may be made over the internet using data encryption technologies to secure the data transmission.

Several embodiments of the financial interactive management system are further described and illustrated by drawings herein included.

### Loan Approval System

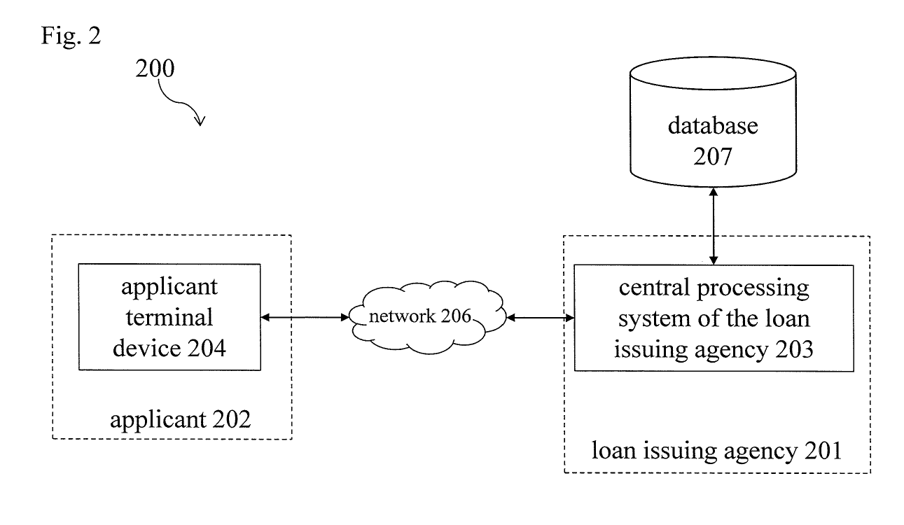

As shown in FIG. 2, a loan approval system 200 is provided to produce a loan approval for distributing working capital to a supplier in a supply chain. The loan approval system 200 is an embodiment of the financial interactive management system 100, where the central processing system 101 interacts with applicants 103 in a supply chain, and with the loan issuing agency 106. The loan approval system 200 may be utilized by various financial institutions including banks, to provide profit margin financings to suppliers to operate in a supply chain.

In one embodiment the loan approval system 200 may include a loan issuing agency 201, one or several applicants 202 who is or are applying for its or their respective loans from the loan issuing agency 201, a central processing system of the loan issuing agency 203, an applicant terminal device 204 used by each applicant 202, relevant information for the determination of a loan approval 205, a network 206 between the loan issuing agency 201 and the applicants 202, one or several databases 207 containing relevant information related to the applicant(s).

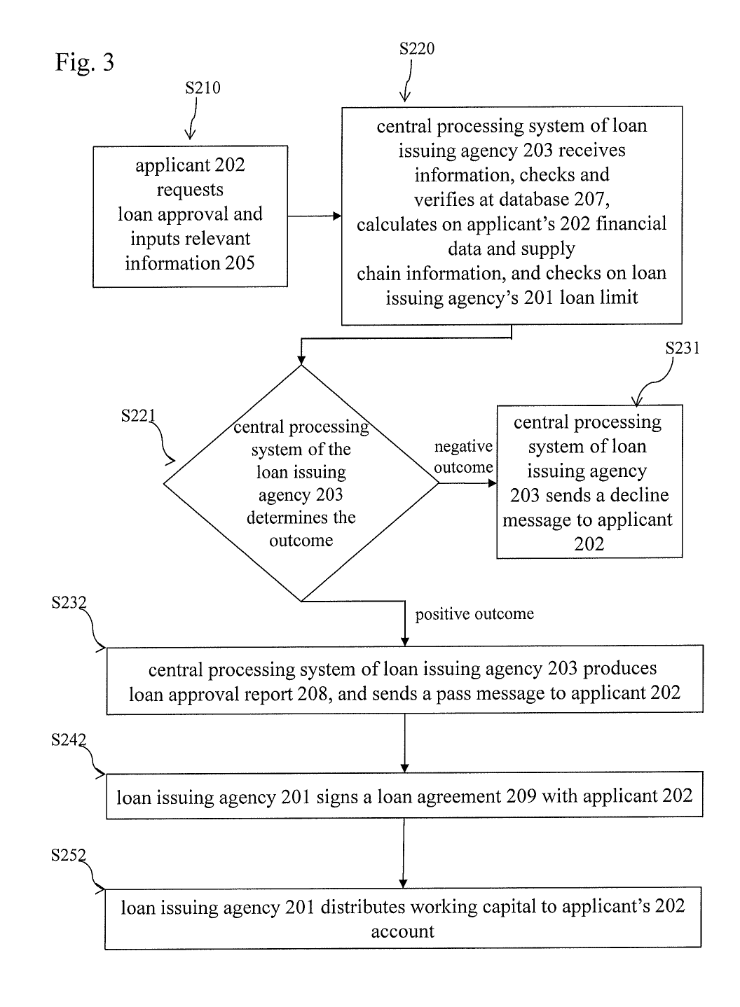

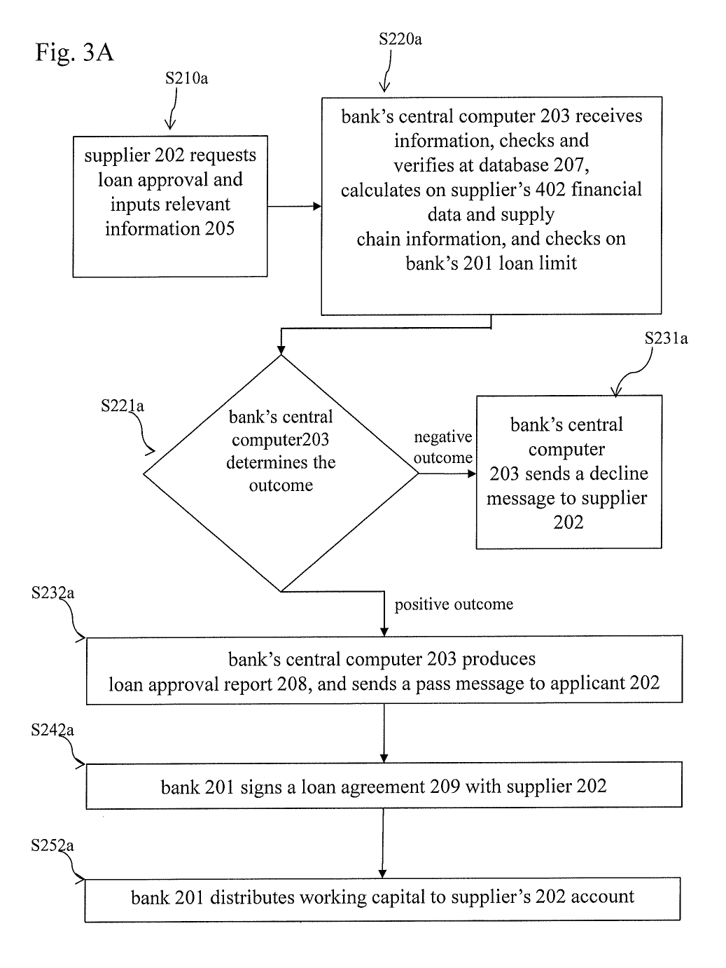

As further illustrated in FIG. 3, in one embodiment several steps are provided to operate the loan approval system 200 which may include:

S210. the applicant 202 requests the loan approval from the loan issuing agency 201 and inputs the relevant information for the determination of the loan approval 205 into its applicant terminal device 204;

S220. following step S210, the central processing system of the loan issuing agency 203 receives the relevant information for the determination of the loan approval 205 for the applicant 202 from the network 206, checks and verifies the information at the database(es) 207 containing information related to the applicants 202, calculates on the applicant's 202 financial data including its gross profit margin and the supply chain information if applicable to the applicant 202, and checks on the loan issuing agency 201's loan limit for the applicant 202;

S221. following step S220, the central processing system of the loan issuing agency 203 determines the outcome of the loan approval;

S231. following step S221, if the central processing system of the loan issuing agency 203 determines the outcome of the loan approval is negative, the central processing system of the loan issuing agency 203 sends a decline message to decline the loan approval to the applicant 202 using the network 206;

S232. following step S221, if the central processing system of the loan issuing agency 203 determines the outcome of the loan approval is positive, the central processing system of the loan issuing agency 203 produces a loan approval report 208 for the applicant 202, and sends a pass message of a confirmation to approve the loan approval to the applicant 202 using the network 206;

S242. following step S232, the loan issuing agency 201 signs a loan agreement 209 with the applicant 202 whose loan approval receives a pass; and

S252. following step S242, the loan issuing agency 201 distributes working capital to the account of the applicant 202 whose loan approval receives a pass.

In one embodiment the loan issuing agency 201 is a bank issuing credit to its various customers pursuant to their loan approval applications.

In another embodiment the several applicants 202 are suppliers in a supplier chain, where a top level supplier receives a purchase order from a buyer to make a purchase from the top level supplier together with a letter of credit from the buyer or the buyer's financial institution for the consideration of the purchase order. Lower level suppliers may contract with the top level supplier for their respective shares in the fulfillment of the purchase order from the buyer. Each applicant 202 applies for its loan approval from the loan issuing agency 201.

In another embodiment, the central processing system for the loan issuing agency 203 is a central processing system of the bank. The central processing system of the loan issuing agency may be any computer with below system configurations, or with any system configurations suitable for its intended purposes in the loan approval system:
browser: Microsoft Internet Explorer 7 or newer, Firefox 3.x or newer, Safari on iPad iOS version 5.x or newer, Google Chrome;
operating System: Microsoft Windows XP SP3 or newer;
RAM (random access memory): 2 GB;
hard drive: 10 GB free;
processor: Pentium dual core equivalent or equivalent AMD CPU.

The loan issuing agency 201 may need a login identification and a password to get access to the central processing system of the loan issuing agency 203 to better secure the processing and transmission of information.

In another embodiment the applicant terminal 204 used by each applicant 202 is a supplier terminal device. In one embodiment the applicant terminal device 204 may be a computer when the relevant information for the determination of the loan approval 205 is in an analog or digital or other computer readable format storable on a data storage medium, and it may also be a printer or other devices which are capable to record and to reproduce relevant information for the determination of a loan approval 205 on paper copies or by other tangible means. The applicant 202 may need an individual login identification and a password to get access to the applicant terminal device 204 to better secure the input and transmission of the information.

In one embodiment the relevant information for the determination of the loan approval 205 may include the applicant's 202 information needed for the determination of the loan approval. In one embodiment when the applicants 202 are suppliers in a supply chain, the relevant information for the determination of the loan approval 205 may include the suppliers' company information, a copy of a buyer's purchase order to make a purchase from the suppliers in the supply chain, information about the supply chain including the suppliers' gross profit margins, the buyer's letter of credit issued by the buyer or its credit agency to a top level supplier in the supply chain, and a proof of account receivable insurances for the suppliers, etc.

Preferably the applicant's 202 gross profit margin in the supply chain is included in the relevant information for the determination of the loan approval 205, because the applicant's 202 gross profit margin may be used to determine the maximum amount of loan required for the applicant 202 to operate in a supply chain transaction utilizing the loan approval system 200. The use of the applicant's 202 gross profit margin in the loan approval system 200 may benefit both the loan issuing agency 201 and the applicant 202, and will be further explained below.

The relevant information for the determination of the loan approval 205 may be in an electronic, computer readable format storable on a data storage medium, and it may also be in some other formats including paper copies or other tangible means. It is to be understood that when the relevant information for the determination of the loan approval 205 is in a tangible format, the information contained therein may be scanned and transformed into a computer readable and processable format and may be thereafter received by the central processing system of the loan issuing agency 203.

The network 206 between the loan issuing agency and the applicants may be either a wired or a wireless network, or any combination or configuration of the two, or via a form of network capable of information compiling and decompiling by the central processing system of the loan issuing agency 203 and the applicant terminal device(s) 204, including wide area network, local area network, digital subscriber line, etc. The network between the loan issuing agency 201 and the applicants 202 may use security socket layer or other encryption technologies to better secure the transmission of information between the loan issuing agency 201 and the applicant(s) 202. It is to be understood that notwithstanding the above embodiments, the network 206 may also be a logistics network employing a carrier or several carriers including first party carrier(s) as part of the applicant 202's logistic system making personal delivery of the relevant information for determination of the loan approval 205, or third party carries or courier service providers to make the same deliveries.

In one embodiment the database(es) 207 containing the relevant information related to the applicants may include the financial interactive management system database 111. The database(es) 207 may also include database(es) publicly accessible and/or database(es) held privately and accessible by subscriptions, and the databases containing the applicant's 202 financial information, credit histories, and other relevant information potentially useful for the determination of the loan approval(s).

Yet in another embodiment as illustrated in FIG. 3A, the steps to operate the loan approval system may be in the following where the loan issuing agency 201 is a bank, the applicant 202 is a supplier in a supply chain, the central processing system of the loan issuing agency 203 is a bank's central computer, the applicant terminal device 204 is a supplier terminal device, and the network 206 is the internet:

S210a. the supplier from a supply chain requests a loan approval from the bank and inputs relevant information for the determination of the loan approval into the loan approval system 200 using the supplier terminal device, e.g. a computer configured to carry out the intended purposes in the loan approval system. The supplier may need an individual login identification and a password to get access to the supplier terminal device to better secure the input and transmission of the relevant information for the determination of the loan approval.

S220a. following step S210a, the bank's central computer receives the relevant information input for the determination of the loan approval from the internet. The bank's central computer checks and verifies the relevant information at database(es) containing information related to the supplier including the financial interactive management system database 111 and/or other relevant databases, calculates on the supplier's financial data including the supplier's gross profit margin and the supply chain information, and checks on bank's loan limit for the supplier who is requesting a loan approval.

In one embodiment the bank's central computer may interact with the financial interactive management system database 111 to access certain information pertinent to the supplier to check and verify whether the relevant information input by the supplier is correct and whether any fraud or default may occur. The bank's central computer may also access to other public or private databases to double check the relevant information input by the supplier to further verify and reassure the authentication and accuracy of the relevant information input by the supplier.

In one embodiment the bank's central computer may use the information received from the supplier and other relevant information from the financial interactive management system database 111 and other relevant databases to calculate on the supplier's financial data including the supply chain information, in deciding the amount of loan to be approved for the supplier. The amount of loan to be approved may be limited by the supplier's gross profit margin the supply chain.

In one embodiment the bank's central computer may recheck on the bank's latest loan limit for the supplier, based on the applicable banking regulations, the bank's loan policies, the bank's capital and liquidity, etc., to reconfirm that the amount of loan to be approved would not exceed the bank's latest loan limit for the supplier.

S221a. following step S220a, the bank's central computer determines the outcome of the loan approval;

S231a. following step S221a, if the bank's central computer determines the outcome of the loan approval is negative, the bank's central computer sends a decline message to decline the loan approval to the supplier using the internet.

In one embodiment the decline message may be sent using the internet electronically by an automated messaging system from the bank's central computer to the supplier terminal device, e.g. a computer, and thereafter is display on the supplier terminal device. In other embodiments the decline message may also be generated by the bank's central computer, printed as a paper copy and sent to the supplier by a logistic network e.g. by mail or via couriers.

S232a. following step S221a, if the bank's central computer determines the outcome of the loan approval is positive (i.e. a pass), the bank's central computer produces a loan approval report 208 for the supplier, and sends a pass message of a confirmation to approve the loan approval 208 to the supplier using the internet.

The loan approval report 208 may include an amount of loan approved and to be issued to the supplier and an interest rate of the loan approved and to be issued to the supplier. In another embodiment, the amount of the loan approved and to be issued is limited to the gross profit margin of the supplier in the supply chain. The amount of the loan approved and to be issued may be further limited by other relevant information including the supplier's credit history, the supplier's other information indicating its riskiness, and certain applicable banking regulations and other laws applicable to the transaction.

The pass message may be sent electronically using the internet by an automated messaging system from the bank's central computer to the supplier terminal device, e.g. a computer, and thereafter is display on the supplier terminal device. In other embodiments the pass message may also be generated by the bank's central computer, printed as a paper copy and sent to the supplier by a logistic network, e.g. by mail or via couriers.

S242a. following step S232a, the bank signs a loan agreement 209 with the supplier whose loan approval receives a pass.

In one embodiment the loan agreement 209 may be in the form of a standardized loan contract. The loan agreement 209 may be in an electronic, computer readable and processable format. In one embodiment the loan agreement 209 may be sent electronically by an automated electronic contract signing system from the bank's central computer to the supplier terminal device, e.g. a computer, and thereafter is display on the supplier terminal device. In one embodiment the supplier whose loan approval receives a pass may sign the loan agreement 209 electronically with a proper identification verification process, i.e. e-signing process. In one embodiment the signed loan agreement 209 may be thereafter stored in the financial interactive management system database 111, or other databases for further references. It is to be understood that, notwithstanding the above embodiment, the loan agreement 209 may also be reproduced in counterparts on a tangible medium including paper, one of which may be send to the supplier whose loan approval receives a pass by a logistic network, e.g. by mail or via couriers for the supplier's signature. The loan agreement 209 including all the counterparts may thereafter be scanned and stored electronically in the financial interactive management system database 111, or other databases for further references. Paper or other tangible copies of the loan agreement 209 may also be stored in their original format for further references.

S252a. following step S242a, the bank distributes working capital to the account of the supplier whose loan approval receives a pass.

The amount of working capital distributed to the account of the supplier whose loan approval receives a pass may equal to the amount of loan approved and to be issued to the supplier in the loan approval report 208 and may equal to the amount of loan allowed in the loan agreement 209 between the bank and the supplier whose loan approval receives a pass. In another embodiment, the amount of working capital distributed to the account of the supplier whose loan approval receives a pass is limited to the gross profit margin of the supplier in the supply chain.

Subsequent to above steps, the supplier may repay the bank the amounts of working capital distributed by the bank to the supplier's account. In one embodiment, the amount of working capital repaid by the supplier may be limited to the gross profit margin of the supplier in the supply chain.

The benefit of utilizing the loan approval system 200 herein described may be explained using an embodiment illustrated in the following Chart 1.

CHART 1
bank loan exposures using loan approval
system and using traditional loan system
(financing loan repayment date for each supplier
is longer than processing time of each supplier)

| | | | | Repayment | |
|---|---|---|---|---|---|
| | Gross | | | of | Total |
| | Margin | | | financing | Tradi- |
| | Financing | | | before | tional |
| | Using | | | receiving | Loan |
| | Loan | | Account | payment | required |
| Contract | Approval | Account | Payable | from one | by each |
| Chain | System | Receivable | Loan | level above | level |
| 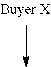 | | | 1,000 K | | 1,000 K |
| 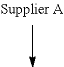 | 350 K (35%) | 1,000 K | 650 K | 0 | 1,000 K |
| 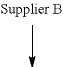 | 160 K (25%) | 650 K | 490 K | 0 | 650 K |
| 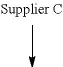 | 100 K (20%) | 490 K | 390 K | 0 | 490 K |
| Supplier D | 390 K | 390 K | | 0 | 390 K |
| Total | 1,000 K | | 2,530 K | 0 | 3,530 K |

In the embodiment illustrated in Chart 1, the loan issuing agency 201 is a bank, and the applicants 202 are several suppliers in a supply chain including Buyer X, and Suppliers A, B, C and D. Supplier A contracts with a Buyer X receiving a purchase order of a purchase price of $1,000,000. Subsequently Supplier A contracts with Supplier B, Supplier B contracts with Supplier C, and Supplier C contracts with Supplier D forming a supply chain in fulfillment of the purchase order. In this embodiment the Buyer X is a buyer with credibility and substantial bargaining power, and Buyer X issues a confirmation letter to Supplier A together with the purchase order confirming the purchase. The confirmation letter subsequently becomes a part of the relevant information for the determination of loan approvals 205 for Suppliers A, B, C and D. The gross profit margins for Suppliers A, B, C and D are 35%, 16%, 10% and 39% respectively.

By utilizing the loan approval system 200 herein described, the bank issues loans to Suppliers A, B, C and D matching their respective gross profit margin, assuming all of Supplier's requests for loan approval receive passes. Consequently the bank issues $350,000 to Supplier A, $160,000 to Supplier B, $100,000 to Supplier C, and $390,000 to Supplier D. The total loan exposure of the bank in the transaction equals to the purchase price in the purchase order, i.e. $1,000,000.

In a traditional loan approval system as shown in Chart 1, the bank is required to issue loans equal to the amount of account receivable of each supplier and the amount of the buyer's purchase price when the financing loan payment date for each supplier is longer than the processing time for each supplier. In the above embodiment, by utilizing the traditional loan approval system when the financing loan payment date for each suppliers is longer than the processing time for each supplier, the bank issues $1,000,000 to Buyer X equal to its purchase price, and issues to Suppliers A, B, C and D amounts of money equal to their respective accounts receivable (i.e. their respective accounts plus their respective gross profit margin). Consequently the bank issues to Suppliers A, B, C and D $1,000,000, $650,000, $490,000 and $390,000 respectively. The bank's total amount of loan exposure is $3,530,000 when utilizing the traditional loan approval system when the financing loan payment date for each supplier is longer than the processing time for each supplier.

CHART 2
bank loan exposures using loan approval
system and using traditional loan system
(financing loan repayment date for each supplier
is shorter than processing time of each supplier)

| | | | | Repayment | |
|---|---|---|---|---|---|
| | Gross | | | of | Total |
| | Margin | | | financing | Tradi- |
| | Financing | | | before | tional |
| | Using | | | receiving | Loan |
| | Loan | | Account | payment | required |
| Contract | Approval | Account | Payable | from one | by each |
| Chain | System | Receivable | Loan | level above | level |
| 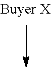 | | | 1,000 K | | 1,000 K |
| 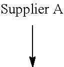 | 350 K (35%) | 1,000 K | 650 K | 650 | 1,650 K |
| 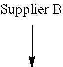 | 160 K (25%) | 650 K | 490 K | 490 | 1,140 K |
| 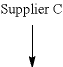 | 100 K (20%) | 490 K | 390 K | 390 | 880 K |
| Supplier D | 390 K | 390 K | | 0 | 390 K |
| Total | 1,000 K | | 2,530 K | 1,530 | 5,060 K |

In another traditional loan approval system as shown in Chart 2, the bank is required to issue loans equal to the amount of the account receivable plus the account payable of each supplier and the amount of the buyer's purchase price when the financing loan payment date for each supplier is shorter than the processing time for each supplier, because each supplier (excluding the lowest level supplier which does not have account payable) may be required to request account receivable loan from the bank to secure its payment when the payment date is due. In the above embodiment, by utilizing the traditional loan approval system when the financing loan payment date for each suppliers is shorter than the processing time for each supplier, the bank issues $1,000,000 to Buyer X equal to its purchase price, and issues to Suppliers A, B, C and D amounts of money equal to their respective accounts receivable plus their respective accounts payable. Consequently the bank issues loans to Suppliers A, B, C and D in the amount of $1,650,000 ($1,000,000+$650,000), $1,140,000 ($650,000+$490,000), $880,000 ($490,000+$390,000) and $390,000 respectively. The bank's total amount of loan exposure is $5,060,000 when utilizing the traditional loan approval system when the financing loan payment date for each supplier is shorter than the processing time for each supplier.

Comparing the bank's loan exposures using the loan approval system 200 herein described in this embodiment to the bank's loan exposures using traditional loan approval system, when using the loan approval system 200 the bank only needs to issue an amount of loan about 1/3.5 (1000/3530) or 1/5.06 (1000/5060) of traditional financing loans, depending on the financing loan payment date relative to the processing time of the supplier. In this embodiment, as the bank only needs to issue the amount of loan equal to 1/3.5 (around 28.57%) or 1/5.06 (around 19.76%) of traditional trade financing loans to all suppliers in a supply chain, the corresponding bank capital reserve required to back up the loans issued in the loan approval system 200 herein described will be only 1/3.5 (around 28.57%) or 1/5.06 (around 19.76%) of traditional trade financing loans.

In general capital reserve of a loan issuing agency 201 only generates very low return to the loan issuing agency 201 while the loan issuing agency 201 needs to pay its shareholders an acceptable return on equity (i.e. cost of capital for the loan issuing agency 201). Employing less bank capital reserve to serve same amount of applicants and transactions means significant cost saving for the loan issuing agency 201. In another embodiment the cost of capital for the loan issuing agency 201 is 8% and return on loan issuing agency 201 capital reserve is 1%. The net savings for loan issuing agency 201 in reducing $1,000,000 capital reserve employed will be $70,000, i.e. $1,000,000×(8%−1%). In the same embodiment there is $50 billion of trade financing loans in the loan issuing agency 201. Utilizing the loan approval system 200 herein described can reduce the loan issuing agency's 201 trade financing loans to $14.29 billion ($50 billion×28.57%), or $9.88 billion ($50 billion×19.76%), when the loan issuing agency's 201 portfolio of supply chains have the average gross margin and supplier level is the same as the embodiment described immediately above. In this embodiment Tier 1 capital is required to be 10% of the loan portfolio of the loan issuing agency 201. Reducing $35.71 billion ($50 billion−$14.29 billion) or $40.12 billion ($50 billion−$9.88 billion) of loan size (while serving the same amount of applicants and same amount of supply chain financing) means annual savings of $250 million ($35.71 billion×10%×7%) or $281 million ($40.12 billion×10%×7%) for the loan issuing agency 201.

When the loan issuing agency 201 saves significant amount in cost of capital in serving same amount of applicants and transactions, the loan issuing agency 201 will be able to provide cheaper financings to the applicant 202, thereby lowering applicant's 202 overall business overhead when operating in a supply chain transaction. This will facilitate the loan issuing agency 201 and applicant 202 to engage in more supply chain business transactions because the loan issuing agency's 201 capital is used more efficiently when the loan approval system 200 herein described is utilized.

It is to be understood that this ratios or percentages may vary if the trade financing portfolio of the loan issuing agency 201 has an average supplier level and average gross margin different from the embodiments described herein. Nonetheless utilizing the loan approval system 200 herein described may cause significant cost savings on the loan issuing agency's 201 capital cost.

### Loan Approval and Guarantee System

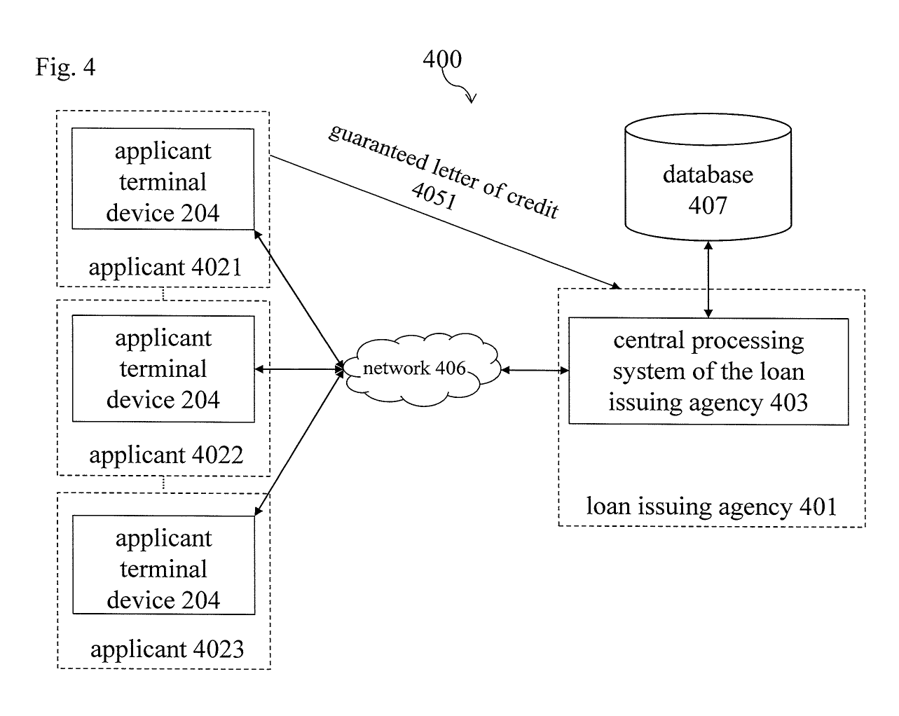

As shown in FIG. 4, a loan approval and guarantee system 400 is provided to produce a guaranteed loan approval for distributing working capital to a supplier in a supply chain, which may be guaranteed by a guaranteed buyer's letter of credit or other forms of payment guarantees. The loan approval and guarantee system 400 is an embodiment of the financial interactive management system 100, where the central processing system 101 interacts with the buyer 102, with applicants 103, 104 and 105 in a supply chain, and with the loan issuing agency 106. The loan approval and guarantee system 400 may be utilized by various credit issuing entities, including banks to provide secured profit margin financings to several suppliers in a supply chain and to further facilitate the supply chain transaction.

In one embodiment the loan approval and guarantee system 400 may include a loan issuing agency 401, several applicants 4021, 4022, 4023 in a transaction who are applying for their respective guaranteed loans from the loan issuing agency 401, a central processing system of the loan issuing agency 403, an applicant terminal device 404 used by each applicant, relevant information for the determination of a guaranteed loan approval 405 further including a guaranteed letter of credit 4051 issued by the buyer or the buyer's financial institution, a network between the loan issuing agency 401 and the applicants 4021, 4022, 4023, one or several databases 407 containing relevant information related to the applicants 4021, 4022, 4023, and several steps to operate the loan approval and guarantee system. In one embodiment the applicants 4021, 4022, 4023 in the transaction further include a top level applicant 4021 in the transaction who contracts directly with a buyer and who receives the guaranteed letter of credit 4051 from the buyer, and one or more lower level applicants 4022, 4023 in the transaction who contract(s) direct with the top level applicant 4021, or indirectly with the top level applicant 4021 through other lower level applicant(s) in a chain of contracts.

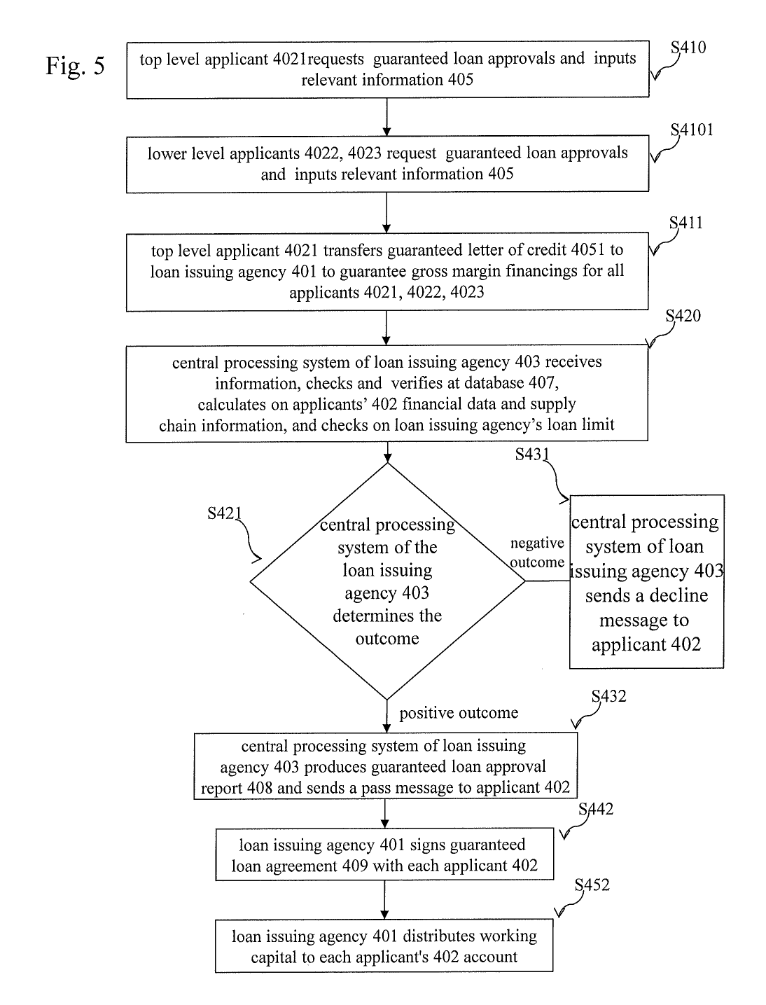

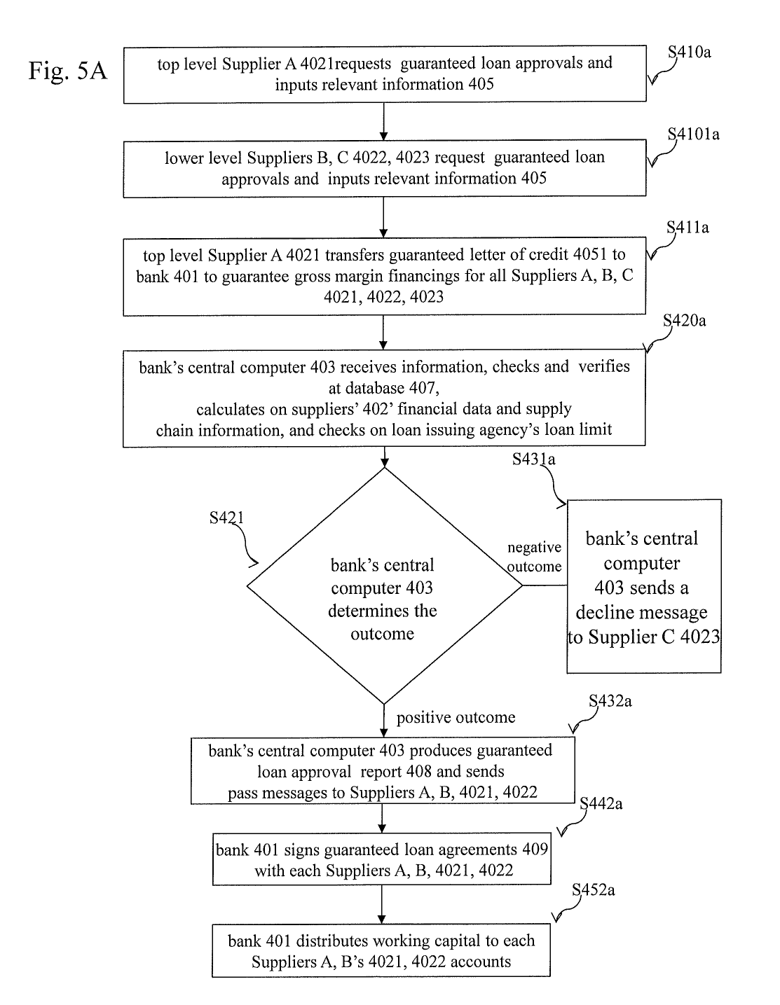

As further illustrated in FIG. 5, in one embodiment the steps are provided to operate the loan approval and guarantee system which may include:

S410. the top level applicant 4021 in the transaction requests the guaranteed loan approval from the loan issuing agency 401 and inputs the relevant information for the determination of the guaranteed loan approval 405 into its applicant terminal device 404;

S4101. the lower level applicants 4022 and 4023 in the transaction request the guaranteed loan approval from the loan issuing agency 401 and input the relevant information for the determination of the guaranteed loan approval 405 into its applicant terminal device 404;

S411. the top level applicant 4021 in the transaction transfers from the network 406 the buyer's guaranteed letter of credit 4051 issued by the buyer or the buyer's financial institution to the loan issuing agency 401 as a collateral to guarantee the guaranteed loan approvals requested by all applicants 4021, 4022, 4023 in the transaction;

S420. following steps S410, S411 and S4101, the central processing system of the loan issuing agency 403 receives the relevant information for the determination of the guaranteed loan approval 405 for the applicant from the network 406 including the guaranteed letter of credit 4051 issued by the buyer or the buyer's financial institution, checks and verifies the relevant information at the database(es) 407 containing information related to each of the applicants 4021, 4022, 4023, calculates on each applicant 402's financial data including its gross profit margin and the supply chain information, and checks on the loan issuing agency 401's loan limit for each applicant 402;

S421. following step S420, the central processing system of the loan issuing agency 203 determines the outcome of the guaranteed loan approval;

S431. following step S421, if the central processing system of the loan issuing agency 403 determines the outcome of the guaranteed loan approval is negative, the central processing system of the loan issuing agency 403 sends a decline message to decline the guaranteed loan approval to the applicant 4021, 4022, 4023 whose guaranteed loan approval receives a decline using the network 406;

S432. following step S421, if the central processing system of the loan issuing agency 403 determines the outcome of the guaranteed loan approval is positive (i.e. a pass), the central processing system of the loan issuing agency 403 produces a guaranteed loan approval report 408 for each applicant, and sends pass message of a confirmation to approve the guaranteed loan approval to the applicant 4021, 4022, 4023 whose guaranteed loan approval receives a pass using the network 406;

S442. following step S432, the loan issuing agency 401 signs a guaranteed loan agreement 409 with each applicant 4021, 4022, 4023 whose guaranteed loan approval receives a pass; and

S452. following step S442, the loan issuing agency 401 distributes working capital to the account of each applicant 4021, 4022, 4023 whose guaranteed loan approval receives a pass.

Embodiments of the loan issuing agency 201 in the loan approval system 200 herein described may be applicable to the loan issuing agency 401 in the loan approval and guarantee system 400.

In one embodiment applicants 4021, 4022, 4023 in the transaction are suppliers in a supplier chain, where the top level applicant 4021 in the transaction is a top level supplier in the supply chain who receives a purchase order from a buyer to make a purchase from the top level supplier in the supply chain together with a guaranteed letter of credit from the buyer or the buyer's financial institution for the consideration of the purchase. In the same embodiment lower level applicants 4022, 4023 are lower level suppliers in the supply chain who contract directly with the top level supplier in the supply chain for their respective shares or gross profit margins in the fulfillment of the purchase order from the buyer. In another embodiment, a lower level applicant 4023 in the transaction contracts with another lower level applicant 4022 in the transaction, the latter of which contracts with the top level applicant 4021 in the transaction, forming a chain of contracts in fulfillment of the purchase order. Each applicant 4021, 4022, 4023 applies for its guaranteed loan approval from the loan issuing agency 401.

Embodiments of the central processing system of loan issuing agency 203 in the loan approval system 200 herein described may be applicable to the central processing system of the loan issuing agency 403 in the loan approval and guarantee system 400.

Embodiments of the applicant terminal device 204 in the loan approval system 200 herein described may be applicable to the applicant terminal device 404 in the loan approval and guarantee system 400.

In one embodiment the relevant information for the determination of the guaranteed loan approval 405 in the loan approval and guarantee system 400 may include information which may be used in the loan approval system 200 herein described. The relevant information for the determination of the guaranteed loan approval 405 in the loan approval and guarantee system 400 further includes a guaranteed letter of credit 4051 issued by the buyer or the buyer's financial institution. In one embodiment the guaranteed letter of credit 4051 issued by the buyer or the buyer's financial institution may be a confirmed letter of credit issued by the buyer or the buyer's financial institution when additional confirmation (or guarantee) is added to honor a complying presentation at the request or authorization of the buyer or the buyer's financial institution. It is to be understood that other forms of payment guarantees may also be used in lieu of the guaranteed letter of credit 4051, including for example buyer's deposit to the loan issuing agency 401, or proofs of account receivable insurances received by applicants 4021, 4022, 4023, and any combinations thereof, so long as the form of the payment guarantees may serve the same functions as of the guaranteed letter of credit in the loan approval and guarantee system 400.

Embodiments of the network 206 in the loan approval system 200 herein described may be applicable to the network 406 in the loan approval and guarantee system 400.

Embodiments of one or several databases 207 containing relevant information related to the applicant(s) 202 in the loan approval system 200 herein described may be applicable to one or several databases 407 containing relevant information related to the applicants 4021, 4022, 4023 in the loan approval and guarantee system 400.

Yet in another embodiment illustrated in FIG. 5A, the several steps to operate the loan approval and guarantee system 400 may be in the following steps where the loan issuing agency 401 is a bank, the applicants 4021, 4022, 4023 in the transaction are suppliers in a supply chain where the top level applicant 4021 in the transaction is a top level supplier in the supply chain, Supplier A, who receives a purchase order from a buyer to make a purchase from the top level supplier in the supply chain together with a guaranteed letter of credit 4051 from the buyer or the buyer's financial institution for the consideration of the purchase, and lower level applicants 4022, 4023 are two lower level suppliers in the supply chain, Suppliers B and C, the former of which contracts directly with Supplier A for its share or gross profit margin in the fulfillment of the purchase order from the buyer, and the latter of which contracts indirectly with Supplier A by contacting with Supplier B for its share or gross profit margin in the fulfillment of the purchase order from the buyer, the central processing system of the loan issuing agency 403 is a bank's central computer, the applicant terminal devices 404 are supplier terminal devices, the guaranteed letter of credit 4051 is a confirmed letter of credit issued by the buyer's financial institution with additional confirmation, and the network 406 is the internet:

S410a. Supplier A requests its guaranteed loan approval from the bank and inputs its relevant information for the determination of the guaranteed loan approval into its supplier terminal device, e.g. a computer configured to carry out the intended purposes in the loan approval and guarantee system. Supplier A may need an individual login identification and a password to get access to the applicant terminal device to better secure the input and transmission of the relevant information for the determination of the guaranteed loan approval 405;

S4101a. lower level Suppliers B and C requests their guaranteed loan approval from the loan issuing agency and input their relevant information for the determination of the guaranteed loan approvals into their supplier terminal devices, e.g. a computers configured to carry out the intended purposes in the loan approval and guarantee system. Suppliers B and C may need individual login identifications and passwords to get access to their applicant terminal devices to better secure the input and transmission of the relevant information for the determination of the guaranteed loan approvals 405;

S411a. Supplier A transfers from the internet the buyer's confirmed letter of credit issued by the buyer's financial institution with additional confirmation as a collateral to guarantee the guaranteed loan approvals requested by all Suppliers A, B and C in the supply chain;

S420a. following step S410a, S411a, 412a and S4101a, the bank's central computer receives Suppliers A, B and C's relevant information input for the determination of the guaranteed loan approvals 405 including the confirmed letter of credit from the internet. The bank's central computer checks and verifies the relevant information at database(es) containing relevant information related to Suppliers A, B and C including the financial interactive management system database 111 and/or other relevant databases, calculates on the suppliers' financial data including the suppliers' gross profit margins and the supply chain information, and checks on bank's loan limit for each of the suppliers who are requesting a guaranteed loan approval.

The bank's central computer may interact with the financial interactive management system database 111 to access certain information pertinent to the Suppliers A, B and C to check and verify whether the relevant information input by Suppliers A, B and C is correct and whether any fraud or default may occur. The bank's central computer may also access to other public or private databases to double check the relevant information input by Suppliers A, B and C to further verify and reassure the authentication and accuracy of the relevant information input by Suppliers A, B and C.

The bank's central computer may use the information received from Suppliers A, B and C and other relevant information from the financial interactive management system database 111 and other relevant databases to calculate on Suppliers A, B and C's financial data including the supply chain information, in deciding the amount of loan to be approved for each of Suppliers A, B and C. The amount of loan to be approved for each of Suppliers A, B and C may matched each of Suppliers A, B and C's gross profit margin the supply chain.

The bank's central computer may recheck on the bank's latest loan limit for each of Suppliers A, B and C, based on the applicable banking regulations, the bank's loan policies, the bank's capital and liquidity, etc., to reconfirm that the amount of loan to be approved for each of Suppliers A, B and C would not exceed the bank's latest loan limit for each of Suppliers A, B and C.

S431a. following step S420a, if the bank's central computer determines the outcome of any one of Suppliers A, B and C's (e.g. Supplier C's) guaranteed loan approval is negative, the bank's central computer sends a decline message to decline the loan approval to the supplier whose guaranteed loan approval receives a decline (e.g. Supplier C) using the internet. The bank's central computer may simultaneously or subsequently send the same decline message to other suppliers (e.g. Suppliers A and B) using the internet to notify other suppliers (e.g. Suppliers A and B) of the decline to approve the guaranteed loan approval to the supplier whose guaranteed loan approval receives a decline (e.g. Supplier C).

The decline message may be sent electronically using the internet by an automated messaging system from the bank's central computer to the supplier terminal device, e.g. a computer, and thereafter is display on the supplier terminal device. In other embodiments the decline message may also be generated by the bank's central computer, printed as a paper copy and sent to the supplier by a logistic network e.g. by mail or via couriers.

S432a. following step S420a, if the bank's central computer determines the outcome of any one of Suppliers A, B and C's (e.g. Supplier B's) guaranteed loan approval is positive (i.e. a pass), the bank's central computer produces a guaranteed loan approval report 408 for the supplier whose guaranteed loan approval receives a sends a pass, and sends a pass message to approve the guaranteed loan approval to the supplier whose guaranteed loan approval receives a pass (e.g. Supplier B) using internet. The bank's central computer may simultaneously or subsequently send the same pass message to other suppliers (e.g. Suppliers A and C) using the internet to notify other suppliers (e.g. Suppliers A and B) of the confirmation to approve the guaranteed loan approval to the supplier whose guaranteed loan approval receives a pass (e.g. Supplier B).

The guaranteed loan approval report 408 may include an amount of guaranteed loan approved and to be issued to the supplier whose guaranteed loan approval receives a pass (e.g. Supplier B), and an interest rate of the loan approved and to be issued to the supplier. In another embodiment, the amount of guaranteed loan approved and to be issued of the supplier whose guaranteed loan approval receives a pass (e.g. Supplier B) is limited to the gross profit margin of the supplier whose guaranteed loan approval receives a pass (e.g. Supplier B) in the supply chain. The amount of guaranteed loan approved and to be issued of the supplier whose guaranteed loan approval receives a pass (e.g. Supplier B) may be further limited by other relevant information of the supplier whose guaranteed loan approval receives a pass (e.g. Supplier B) including its credit history, other information indicating its riskiness, and certain applicable banking regulations and other laws applicable to the transaction.

The pass message may be sent electronically using the internet by an automated messaging system from the bank's central computer to the supplier terminal device, e.g. a computer, and thereafter is display on the supplier terminal device. In other embodiments the approval confirmation message may also be generated by the bank's central computer, printed as a paper copy and sent to the supplier by a logistic network, e.g. by mail or via couriers.

S442a. following step S432a, the bank signs a guaranteed loan agreement 409 with the supplier whose guaranteed loan approval receives a pass (e.g. Supplier B).

The loan agreement 409 may be in the form of a standardized guaranteed loan contract. The guaranteed loan agreement 409 may be in an electronic, computer readable and processable format. The guaranteed loan agreement 409 may be sent electronically by an automated electronic contract signing system from the bank's central computer to the supplier terminal device, e.g. a computer, and thereafter is display on the supplier terminal device. The supplier whose guaranteed loan approval receives a pass (e.g. Supplier B) may sign the guaranteed loan agreement 409 electronically with a proper identification verification process, i.e. e-signing process. The signed guaranteed loan agreement 409 may be thereafter stored in the financial interactive management system database 111, or other databases for further references. It is to be understood that, notwithstanding the above embodiment, the guaranteed loan agreement 409 may also be reproduced in counterparts on a tangible medium including paper, one of which may be send to the supplier by a logistic network, e.g. by mail or via couriers for the supplier's signature. The guaranteed loan agreement 409 including all the counterparts may thereafter be scanned and stored electronically in the financial interactive management system database 111, or other databases for further references. Paper or other tangible copies of the guaranteed loan agreement may also be stored in their original format for further references.

S452a. following step S442a, the bank distributes working capital to the account of the supplier whose guaranteed loan approval receives a pass (e.g. Supplier B).

The amount of working capital distributed to the account of the supplier whose guaranteed loan approval receives a pass (e.g. Supplier B) may equal to the amount of loan approved and to be issued to the supplier in the guaranteed loan approval report 408 and may equal to the amount of loan allowed in the guaranteed loan agreement 409 between the bank and the supplier whose loan approval receives a pass (e.g. Supplier B). In another embodiment, the amount of working capital distributed to the account of the supplier whose guaranteed loan approval receives a pass (e.g. Supplier B) is limited to the gross profit margin of the supplier whose guaranteed loan approval receives a pass (e.g. Supplier B) in the supply chain.

Subsequent to above steps, the suppliers may repay the bank the amount of working capital distributed by the bank to the suppliers' accounts. In one embodiment, the amount of working capital repaid by the suppliers may be limited to the gross profit margins of the suppliers in the supply chain. In one embodiment the suppliers may repay the amount of working capital distributed to their accounts after the guaranteed letter of credit makes a payment pursuant to the buyer's approval.

Benefits from using the loan approval and guarantee system 400 includes the benefits from using the loan approval system 200 herein described. In addition, in the loan approval and guarantee system 400 only the top level applicant 4021 transfers the guaranteed letter of credit 4051 to the loan issuing agency 401 as a collateral to the financings to all applicants 4021, 4022, 4023 in the transaction; therefore other applicants 4022, 4023 in the transaction may not have to provide additional collaterals or guarantees to the loan issuing agency 401 to secure their loans. Thus the loan approval and guarantee system 400 may reduce the transaction costs and waiting times of the applicants 4021, 4022, 4023 in a supply chain transaction by simplifying the loan application and determination process. By utilizing the loan approval and guarantee system 400 it may also relieve smaller lower level applicants 4022, 4023 from the burden of proving its ability to repay the loan, and may reduce the costs of capital for all applicants 4021, 4022, 4023, especially the smaller lower level applicants 4022, 4023, because all applicants 4021, 4022, 4023 in the a supply chain are effectively guaranteed by the guaranteed letter of credit 4051.

### Insurance Underwriting Approval System

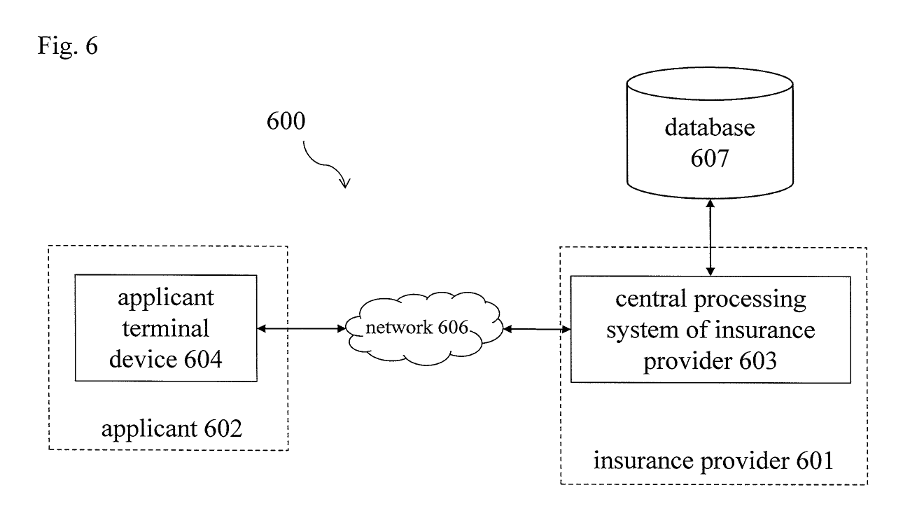

As shown in FIG. 6, an insurance underwriting approval system 600 is provided to produce an approval report for providing insurance to a supplier in a supply chain. The insurance underwriting system 600 is an embodiment of the financial interactive management system 100, where the central processing system 101 interacts with applicants 103, 104 and 105 in a supply chain, and with the insurance provider 107. The insurance underwriting approval system 600 may be utilized by various insurance providers, including insurance companies to provide insurances to suppliers in a supply chain and to facilitate a supply chain transaction.

In one embodiment The insurance underwriting approval system 600 may include an insurance provider 601, one or several applicants 602 who is or are applying for its or their respective insurances from the insurance provider 601, a central processing system of the insurance provider 603, an applicant terminal device 604 used by each applicant, relevant information for the determination of an insurance approval 605, a network 606 between the insurance provider 601 and the applicants 602, one or several databases 607 containing relevant information related to the applicant(s).

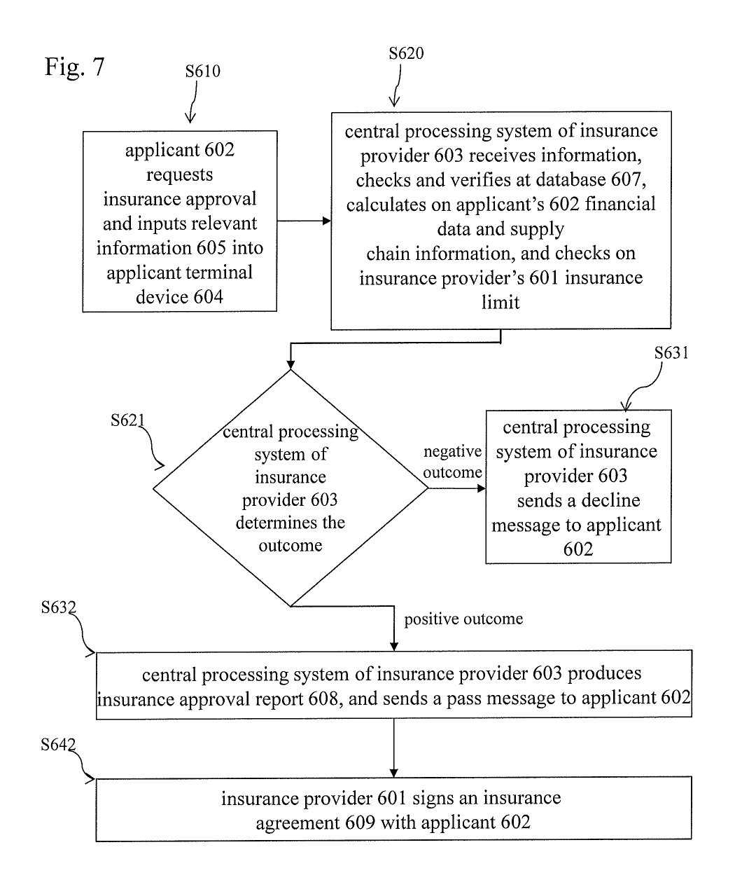

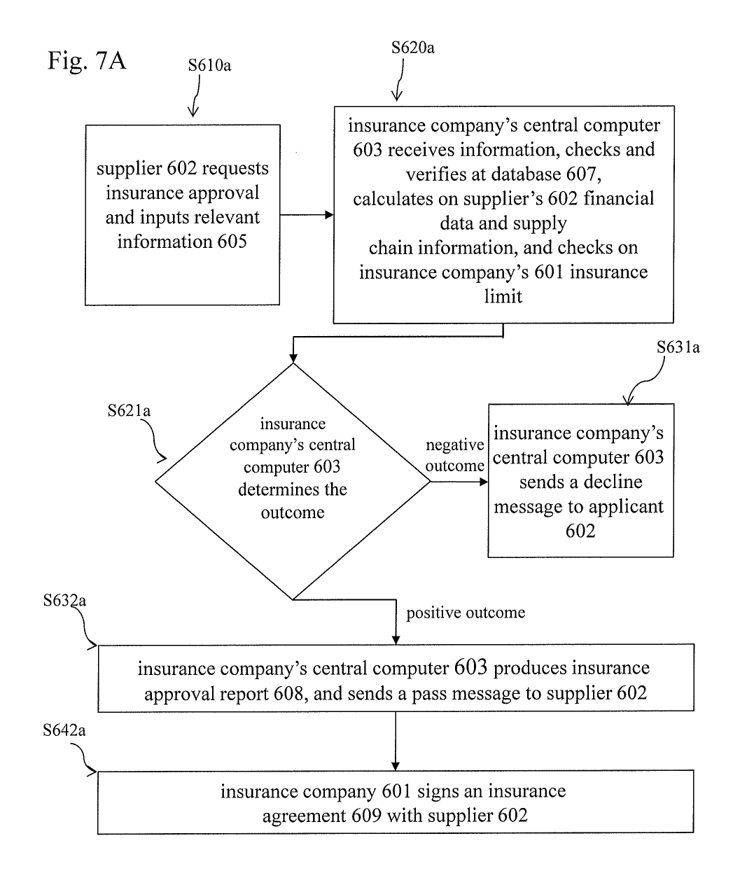

As further illustrated in FIG. 7, in one embodiment the several steps are provided to operate the insurance underwriting approval system which may include:

S610. the applicant 602 requests the insurance approval from the insurance provider 601 and inputs the relevant information for the determination of the insurance approval 605 into its applicant terminal device 604;

S620. following step S610, the central processing system of the insurance provider 603 receives the relevant information for the determination of the insurance approval 605 for the applicant 602 from the network 606, checks and verifies the information at database(es) 607 containing information related to the applicants 602, calculates on the applicant 602's financial data including its gross profit margin and the supply chain information if applicable to the applicant 602, and checks on the insurance provider 601's insurance limit for the applicant 602;

S621. following step 611, the central processing system of the insurance provider 603 determines the outcome of the insurance approval;

S631. following step S621, if the central processing system of the insurance provider 603 determines the outcome of the insurance approval is negative, the central processing system of the insurance provider 603 sends a decline message to decline the insurance approval to the applicant 602 using the network 606;

S632. following step S621, if the central processing system of the insurance provider 603 determines the outcome of the applicant 602's insurance approval is positive, the central processing system of the insurance provider 603 produces an insurance approval report 608 for the applicant 602 including an insurance premium applicable to the applicant 602, and sends a pass message of a confirmation to approve the insurance approval to the applicant 602 using the network 606;

S642. following step S632, the insurance provider 601 signs an insurance agreement 609 with the applicant 602 whose insurance approval receives a pass; and

In one embodiment the insurance provider 601 is an insurance company issuing issuances to its various customers pursuant to their insurance approval applications. Preferably, an insurance provider 601 may be a subsidiary of the loan issuing agency 201 in a loan approval system 201, because the insurance provider 601 may coordinate with the loan issuing agency 201 to facilitate the insurance approvals as well as the loan approvals.

In another embodiment, the several applicants 602 are suppliers in a supplier chain, where a top level supplier receives a purchase order from a buyer to make a purchase from the top level supplier together with a letter of credit from the buyer or the buyer's financial institution for the consideration of the purchase order. Lower level suppliers may contract with the top level supplier for their respective shares in the fulfillment of the purchase order from the buyer. Each supplier applies for its insurance approval from the insurance provider 601.

In another embodiment, the central processing system for the insurance provider 603 is a central processing system of the insurance company. The central processing system of the insurance provider 603 may be any computer with below system configurations, or with any system configurations suitable for its intended purposes in the insurance underwriting approval system:
browser: Microsoft Internet Explorer 7 or newer, Firefox 3.x or newer, Safari on iPad iOS version 5.x or newer, Google Chrome;
operating System: Microsoft Windows XP SP3 or newer;
RAM (random access memory): 2 GB;
hard drive: 10 GB free;
processor: Pentium dual core equivalent or equivalent AMD CPU.

In one embodiment the insurance provider 601 may need a login identification and a password to get access to the central processing system of the insurance provider 603 to better secure the processing and transmission of information.

In another embodiment the applicant terminal 604 used by each applicant 602 is a supplier terminal device. In other embodiments the applicant terminal device 604 may be a computer when the relevant information for the determination of the insurance approval 605 is in an analog or digital or other computer readable format storable on a data storage medium, and it may also be a printer or other devices which are capable to record and reproduce relevant information for the determination of the insurance approval 605 on paper copies or by other tangible copies. The applicant 602 may need an individual login identification and a password to get access to the applicant terminal device 604 to better secure the input and transmission of information.

In one embodiment the relevant information for the determination of the insurance approval 605 may include the applicant 602's information needed for a determination of the insurance approval. In one embodiment when the applicants 602 are suppliers in a supply chain, the relevant information for the determination of the insurance approval 605 may include the suppliers' company information, a copy of a buyer's purchase order to make a purchase from the suppliers in the supply chain, information about the supply chain including the suppliers' gross profit margins, and the buyer's letter of credit provided by the buyer or its credit agency to the top level supplier in the supply chain, etc.

Preferably the applicants' 602 gross profit margins is included in the relevant information for the determination of the insurance approval 605 because a applicant's 602 gross profit margin may be used to determine the maximum amount of insurance required for the applicant 602 to operate in a supply chain transaction also utilizing the loan approval system 200. The use of a applicant's 602 gross profit margin in the insurance underwriting approval system 600 may benefit both the insurance provider 601 and the applicant 602, and will be further explained below.

In one embodiment the relevant information for the determination of the insurance approval 605 may be in an electronic, computer readable format storable on a data storage medium, and it may also be in some other formats including paper copies or other tangible copies, etc. It is to be understood that when the relevant information for the determination of the insurance approval 605 is in a tangible format, the information contained therein may be scanned and transformed into a computer readable and processable format and may be thereafter received by the central processing system of the insurance provider 603.

In one embodiment the network 606 between the insurance provider 601 and the applicants 602 may be either a wired or a wireless network, or any combination or configuration of the two, or via a form of network capable of information compiling and decompiling by the central processing system of the insurance provider 603 and the applicant terminal devices 604, including wide area network, local area network, digital subscriber line, etc. In one embodiment the network 606 between the insurance provider 601 and the applicants 602 may use security socket layer or other encryption technologies to better secure the transmission of information between the insurance provider 601 and the applicants 602. It is to be understood that notwithstanding the above embodiments, the network 606 may also be a logistics network employing a carrier or several carriers including first party carrier(s) as part of the applicant's 602 logistic system making personal deliveries of the relevant information for determination of the insurance approval 605, or third party carries or courier service providers with similar functions.

In one embodiment the database(es) 607 containing the relevant information related to the applicants 602 may include a financial interactive management system database 111. In one embodiment the database(es) 607 may also include database(es) publicly accessible and/or database(es) held privately and accessible by subscriptions, and the databases 607 contain the supplier's or the suppliers' financial information, credit histories, and other relevant information potentially useful for the determination of the insurance approval(s).

Yet in another embodiment illustrated in FIG. 7A, the several steps to operate the insurance underwriting approval system may be in the following where the insurance provider 601 is an insurance company, the applicant 602 is a supplier in a supply chain, the central processing system of the insurance provider 603 is an insurance company's central computer, the applicant terminal device 604 is an applicant terminal device, and the network is the internet:

S610a. the supplier in a supply chain requests an insurance approval from the insurance company and inputs relevant information for the determination of the insurance approval 605 into the insurance underwriting approval system using the supplier terminal device, e.g. a computer configured to carry out the intended purposes in the insurance underwriting approval system. The supplier may need an individual login identification and a password to get access to the supplier terminal device to better secure the input and transmission of the relevant information for the determination of the insurance approval.

S620a. following step S610a, the insurance company's central computer receives the relevant information input for the determination of the insurance approval from the internet. The insurance company's central computer checks and verifies the relevant information at database(es) containing information related to the supplier including the financial interactive management system database 111 and/or other relevant databases, calculates on the supplier's financial data including the supplier's gross profit margin and the supply chain information, and checks on insurance company's insurance limit for the supplier who is requesting an insurance approval.

In one embodiment the insurance company's central computer may interact with the financial interactive management system database 111 to access certain information pertinent to the supplier to check and verify whether the relevant information input by the supplier is correct and whether any fraud or default may occur. In one embodiment the insurance company's central computer may also access to other public or private databases to double check the relevant information input by the supplier to further verify and reassure the authentication and accuracy of the relevant information input by the supplier.

In one embodiment the insurance company's central computer may use the information received from the supplier and other relevant information from the financial interactive management system database 111 and other relevant databases to calculate on the supplier's financial data including the supply chain information, in deciding the amount of insurance to be approved for the supplier and the insurance premium for the supplier. In one embodiment the amount of insurance to be approved may be limited by the supplier's gross profit margin the supply chain.

In one embodiment the insurance company's central computer may recheck on the insurance company's latest insurance limit for the supplier, based on the applicable insurer regulations, the insurance company's insurance policies, the insurance company's capital and liquidity, etc., to reconfirm that the amount of insurance to be approved would not exceed the insurance company's latest insurance limit for the supplier.

S621a. the insurance company's central computer determine the outcome of the insurance approval.

S631a. following step S621a, if the insurance company's central computer determines the outcome of the insurance approval is negative, the insurance company's central computer sends a decline message to decline the insurance approval to the supplier using the internet.

The decline message may be sent electronically using the internet by an automated messaging system from the insurance company's central computer to the supplier terminal device, e.g. a computer, and thereafter is display on the supplier terminal device. In other embodiments the decline message may also be generated by the insurance company's central computer, printed as a paper copy and sent to the supplier by a logistic network e.g. by mail or via couriers.

S632a. following step S621a, if the insurance company's central computer determines the outcome of the insurance approval is positive (i.e. a pass), the insurance company's central computer produces an insurance approval report 608 for the supplier, and sends a pass message of a confirmation to approve the insurance approval to the supplier using the internet.

The insurance approval report 608 may include the amount of insurance approved and to be provided to the supplier, and may also include the insurance premium for the supplier. In another embodiment, the amount of the insurance approved and to be provided is limited to the gross profit margin of the supplier in the supply chain. The amount of the insurance approved and to be provided may be further limited by other relevant information including the supplier's credit history, the supplier's other information indicating its riskiness, and certain applicable insurance companying regulations and other laws applicable to the transaction.

The pass message may be sent electronically using the internet by an automated messaging system from the insurance company's central computer to the supplier terminal device, e.g. a computer, and thereafter is display on the supplier terminal device. In other embodiments the pass message may also be generated by the insurance company's central computer, printed as a paper copy and sent to the supplier by a logistic network, e.g. by mail or via couriers.

S642a. following step S632a, the insurance company signs an insurance agreement 609 with the supplier whose insurance approval receives a pass.

The insurance agreement 609 may be in the form of a standardized insurance contract. The insurance agreement 609 may be in an electronic, computer readable and processable format. The insurance agreement 609 may be sent electronically by an automated electronic contract signing system from the insurance company's central computer to the supplier terminal device, e.g. a computer, and thereafter is displayed on the supplier terminal device. The supplier whose insurance approval receives a pass may sign the insurance agreement 609 electronically with a proper identification verification process, i.e. e-signing process. The signed insurance agreement 609 may be thereafter stored in the financial interactive management system database 111, or other databases for further references. It is to be understood that, notwithstanding the above embodiment, the insurance agreement 609 may also be reproduced in counterparts on a tangible medium including paper, one of which may be send to the supplier whose insurance approval receives a pass by a logistic network, e.g. by mail or via couriers for the supplier's signature. The insurance agreement 609 including all the counterparts may thereafter be scanned and stored electronically in the financial interactive management system database 111, or other databases for further references. Paper or other tangible copies of the insurance agreement 609 may also be stored in their original format for further references.

In one embodiment the supplier whose insurance approval receives a pass may subsequently pay the insurance premium to the insurance company, and the insurance company may provide insurance to the supplier whose insurance approval receives a pass.

The amount of insurance provided to the supplier whose insurance approval receives a pass may equal to the amount of insurance approved and to be provided to the supplier in the insurance approval report and may equal to the amount of insurance allowed in the insurance agreement between the insurance company and the supplier whose insurance approval receives a pass. In another embodiment, the amount of working capital distributed to the account of the supplier whose insurance approval receives a pass is limited to the gross profit margin of the supplier in the supply chain.

Utilizing the insurance underwriting approval system 600 may save the insurance provider 601 significant amount of cost in its cost of reserves. The cost savings to the insurance provider 601 may be illustrated using the relevant components in the embodiment of the loan approval system 200 illustrated in Chart 1. In that embodiment, there is no (0%) deposit from Buyer X, and an insurance company as the insurance provider 601 may by requests provide insurances covering the supply chain. By utilizing the insurance underwriting approval system 600 herein described, the insurance company needs to provide insurances in the total amount of $1,000,000 for Suppliers A, B, C and D in the supply chain. In a traditional insurance underwriting system, the insurance company needs to provide insurances in the total amount of $2,530,000 (the total amount of the accounts receivables of Suppliers A, B, C and D) for Suppliers A, B, C and D to cover the potential account receivable risks in supply chain. Therefore in this embodiment the insurance company utilizing the insurance underwriting approval system 600 descried herein only needs to guarantee about 1/2.5 (1000/2530), i.e. 40%, of traditional trade financing accounts receivable to all the suppliers in a supply chain.

As the insurance company utilizing the insurance underwriting approval system 600 herein described only needs to guarantee about 1/2.5 (40%) of traditional trade financing accounts receivable to all suppliers in a supply chain, the corresponding reserves required utilizing the insurance underwriting approval system 600 herein described will be only about 40% (1000/2530) of traditional trade financing receivables.

In general the insurance provider's 601 reserve only generates very low return to the insurance provider 601 while insurance provider 601 needs to pay its shareholders an acceptable return on equity (i.e. cost of capital for the insurance provider 601). Employing less reserve to serve same amount of applicants and transactions means significant cost saving for the insurance provider 601. In another embodiment the cost of capital for the insurance provider 601 is 10% and return on the insurance provider's 601 reserve is 1%. The net saving for insurance provider in reducing US$1 million insurance provider 601 reserve employed will be $90,000, i.e. $1 million×(10%−1%). In the same embodiment there is $50 billion of account receivable insurance policy in the insurance provider, utilizing the insurance underwriting approval system 600 herein described can reduce the insurance provider's 601 account receivable insurance policy to $20 billion (i.e. US$50 billion×40%). In this embodiment the insurance provider 601 is required to keep 5% of the account receivable insurance policy as reserves. Therefore reducing $30 billion (i.e. $50 billion−$20 billion) of account receivable insurance policy (while serving the same amount of applicants and same amount of supply chain financing transaction) means annual savings of $135 million (i.e. $30 billion×5%×9%) for the insurance provider 601.

When the insurance provider 601 saves significant amount in cost of reserves in serving same amount of applicants and transactions, the insurance provider 601 will be able to provide cheaper insurance premiums to the applicants 602, thereby lowering applicants' 602 overall business overhead in operation in a supply chain transaction. Consequently it will facilitate the insurance provider 601 and applicants 602 to engage in more supply chain business transactions because the insurance provider's reserves are used more efficiently based when the insurance underwriting approval system 600 described herein is utilized.

It is to be understood that the ratio and percentage may change if the account receivable insurance portfolio of the insurance provider 601 has an average supplier level and average gross margin different from those embodiments described herein. Nonetheless utilizing the insurance underwriting approval system 600 may cause significant cost savings on the insurance provider's 601 cost of reserves.

### Supply Chain Management System

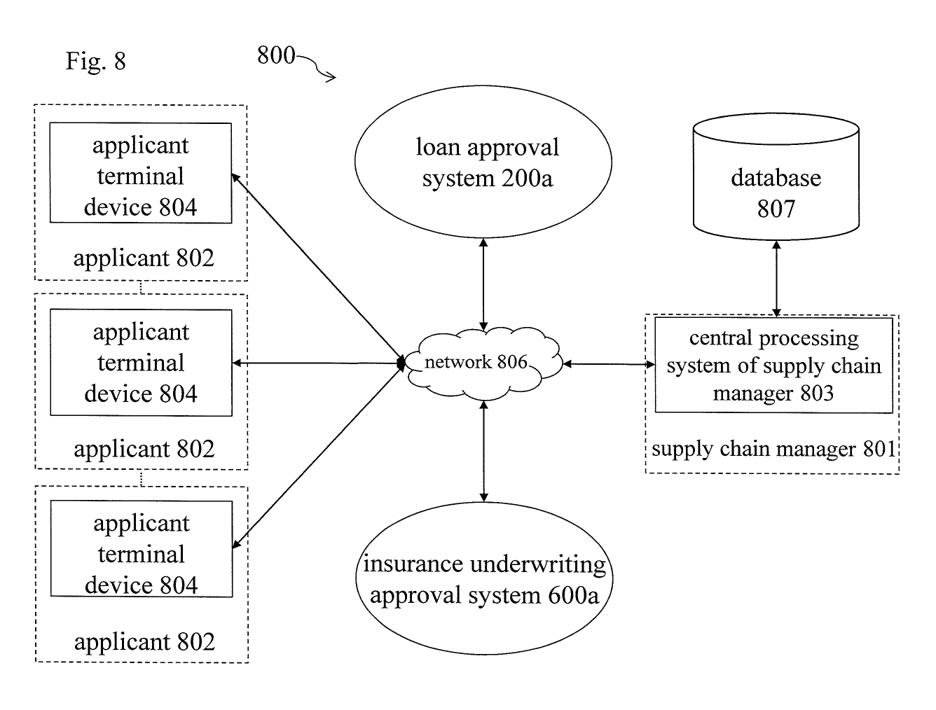

As shown in FIG. 8, a supply chain management system 800 is provided for a supply chain with multiple suppliers, to link suppliers' contracts, product flow and payment transactions together to form a chain to apply loans from a bank, with guarantee from the top level to bottom level of suppliers in a supply chain. The supply chain management system 800 is an embodiment of the financial interactive management system 100, where the central processing system 101 interacts with applicants 103 in a supply chain, the supply chain manager 108, and potentially with the loan issuing agency 106 and the insurance provider 107. In one embodiment the supply management system 800 may be operated by an independent e-commerce service provide, otherwise it may also be operated by a loan issuing agency or other entities capable of carrying out the various functions of the supply chain management system 800.

In one embodiment the supply chain management system 800 may include a supply chain manager 801, several applicants 802 in a supply chain, a central processing system of the supply chain manager 803, an applicant terminal device 804 for each applicant, a loan approval system 200a where the applicants 802 in the loan approval system 200a are applicants 802 in a supply chain, a supply chain management database 807, and a network 806.

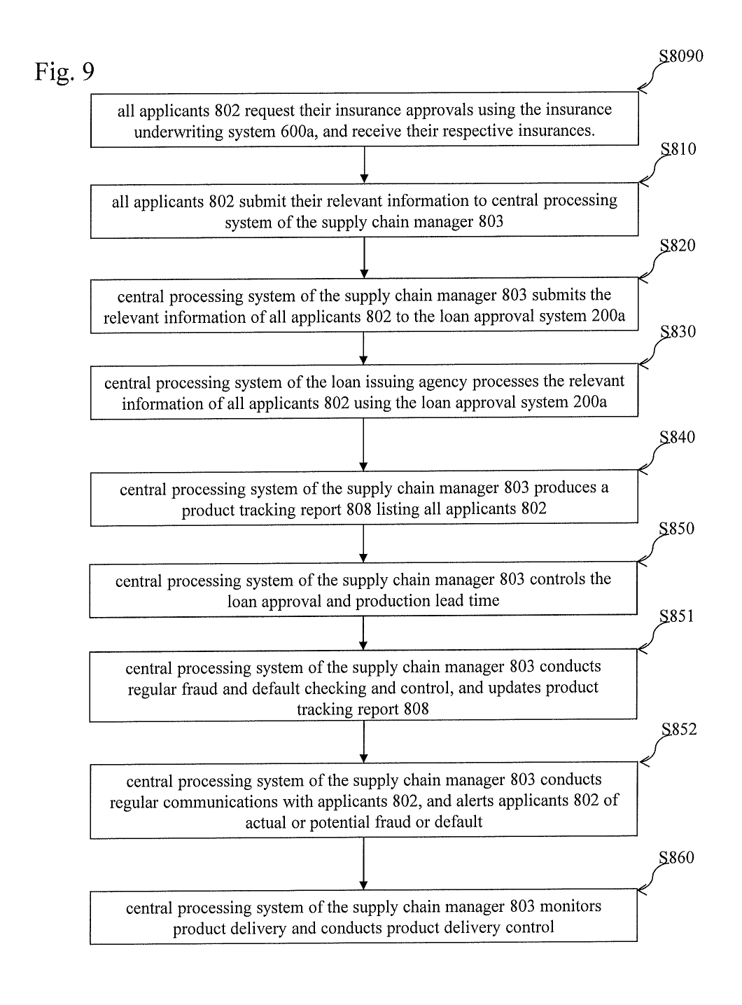

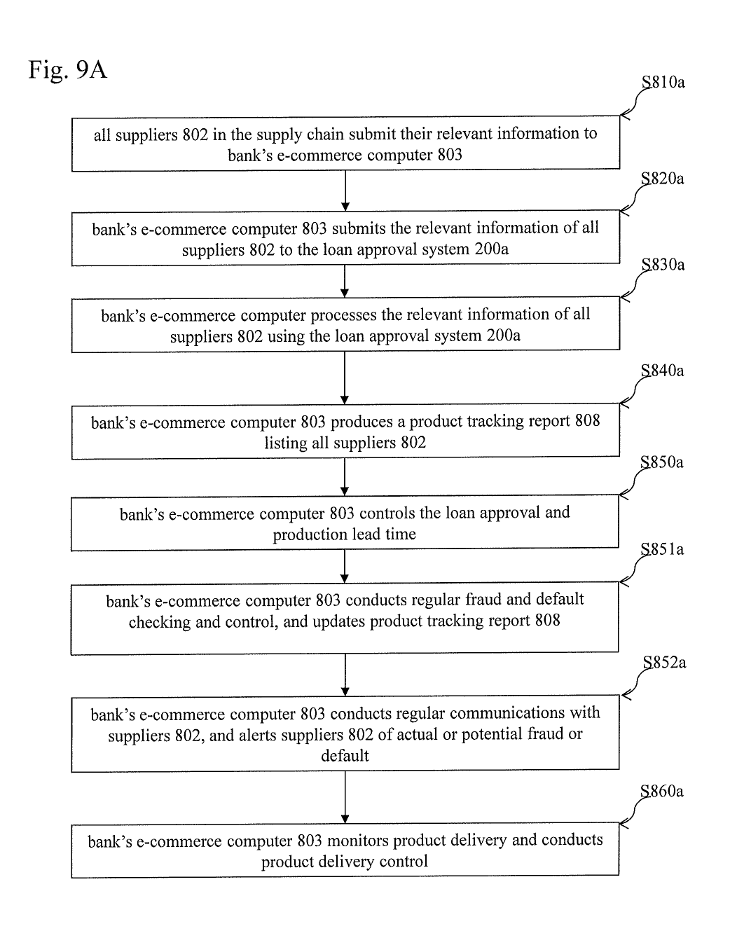

As further illustrated in FIG. 9, in one embodiment several steps are provided to operate the supply chain management system 800 which may include:

S810. all applicants 802 in the supply chain submit their relevant information including the supply chains contract information to the central processing system of the supply chain manager 803 using their applicant terminal devices 804 over the network 806;

S820. the central processing system of the supply chain manager 803 submits the relevant information of all applicants 802 in the supply chain to the central processing system of the loan issuing agency in the loan approval system 200a over the network 806;

S830. the central processing system of the loan issuing agency processes the relevant information of all applicants 802 in the supply chain using the loan approval system 200a, establishing a credit chain of all applicants;

S840. the central processing system of the supply chain manager 803 produces a product tracking report 808 listing all applicants 802 in the supply chain establishing a product chain of all applicants, and keeps the product tracking report 808 in the supply chain management database 807;

S850. the central processing system of the supply chain manager 803 controls the loan approval and the production lead time over the network 806, accesses the supply chain management database 807 and updates the product tracking report 808 over the network 806;

S851. the central processing system of the supply chain manager 803 conducts regular fraud and default checking and control over the network 806, accesses the supply chain management database 807 and updates the product tracking report 808 over the network 806;

S852. the central processing system of the supply chain manager 803 conducts regular communications with applicants 802, and alerts applicants 802 of an actual or potential fraud or default;

S860. the central processing system of the supply chain manager 803 monitors product delivery over the network 806, and conducts product delivery control over the network 806.

It is to be understood that the supply chain management system 800 may further include an insurance underwriting system 600a described herein where the applicants in the insurance underwriting system 600a are applicants 802 in a supply chain in the supply chain management system 800, and an additional step S8090 before step S810 herein described:

S8090. all applicants 802 in the supply chain request their insurance approvals using the insurance underwriting system 600a over the network 806, and receive their respective insurances.

In another embodiment the supply chain manager 801 may be an e-commerce portal operator. The supplier chain manager 801 may also be a department of the loan issuing agency in the loan approval system, e.g. an e-commerce department in a bank which also is the loan issuing agency in a loan approval system.

In another embodiment the applicants 802 in the supply chain are suppliers in a supply chain, where a top level supplier receives a purchase order from a buyer to make a purchase from the top level supplier together with a letter of credit from the buyer or the buyer's financial institution for the consideration of the purchase order. In the same embodiment lower level applicants 802 are lower level suppliers in the supply chain who contract directly with the top level supplier in the supply chain for their respective shares or gross profit margins in the fulfillment of the purchase order from the buyer. In another embodiment, a lower level applicant 802 in the transaction contracts with another lower level applicant in the transaction, the latter of which contracts with the top level applicant in the transaction, forming a chain of contracts in fulfillment of the purchase order.

In another embodiment, the central processing system for the supply chain manager 801 is a central computer of an e-commerce portal provider. The central processing system for the supply chain manager 801 may also be the central processing system of the loan issuing agency when the supply chain manager 801 is the loan issuing agency in the loan approval system. The central processing system of the supply chain manager 803 may be any computer with below system configurations or with any system configurations suitable for its intended purposes in the supply chain management system:
browser: Microsoft Internet Explorer 7 or newer, Firefox 3.x or newer, Safari on iPad iOS version 5.x or newer, Google Chrome;
operating System: Microsoft Windows XP SP3 or newer;
RAM (random access memory): 2 GB;
hard drive: 10 GB free;
processor: Pentium dual core equivalent or equivalent AMD CPU.

In one embodiment the supply chain manager 801 may need a login identification and a password to get access to the central processing system of the supply chain manager 803 to better secure the processing and transmission of information.

In another embodiment the applicant terminal device 804 for each applicant is a applicant terminal device 204 in the loan approval system 200a. Embodiments of the applicant terminal device 204 in the loan approval system 200 herein described may be applicable to the applicant terminal device 804 in the supply chain management system 800.

Embodiments of the components and steps of the loan approval system 200 herein described may be applicable to the loan approval system 200a in the supply chain management system 800.

In one embodiment the supply chain management database 807 may be the financial interactive management system database 111. The supply chain management database 807 may also be another database specially configured for its intended purposes in the supply chain management including storing relevant information in the supply chain management system, being capable to be accessed from the central processing system of the supply chain manager 803, and being capable to update information contained in the supply chain management database 807 following directions from the central processing system of the supply chain management system.

Embodiments of the network 206 in the loan approval system 200 herein described may be applicable to the network 806 in the supply chain management system 800.

Yet in another embodiment illustrated in FIG. 9A, the several steps to operate the supply chain management system may be the following where the supply chain manager 801 is an e-commerce department of a bank which is also the loan issuing agency in the loan approval system 200a, where the applicants 802 in the supply chain are suppliers in a supply chain, the central processing system of the supply chain manager 803 is the bank's e-commerce computer which may also be the bank's central computer in the loan approval system 200a, the applicant terminal devices 804 are applicant terminal devices, the supply chain management database 807 is a financial interactive management system database 111, and the network 806 is the internet:

S810a. all suppliers in the supply chain submit their relevant information including the supply chains contract information to the bank's e-commerce computer using their applicant terminal devices. The suppliers in the supply chain may submit their relevant information using the internet.

S820a. the bank's e-commerce computer submits the relevant information of all suppliers in the supply chain to the bank's central computer in the loan approval system 200a. the bank's e-commerce computer may submit the relevant information of all suppliers in the supply chain to using the internet.

S830a. the bank's central computer processes the relevant information of all suppliers in the supply chain using the loan approval system, establishing a credit chain of all suppliers in the supply chain.

S840a. the bank's e-commerce computer produces a product tracking report listing all applicants 802 in the supply chain over the internet establishing a product chain of all suppliers in the supply chain, and keeps the product tracking report in the financial interactive management system database 111 over the internet.

In one embodiment the product tracking report may include information relating the processing of the buyer's purchase order, e.g. contracts between suppliers, amount and prices for raw materials acquired, shipment information, and bills of lading, etc. In one embodiment the information contained in the product tracking report may be submitted by suppliers using their applicant terminal devices, or may be acquired accessing other database(es) containing relevant information.

In one embodiment the transmission of information in the supply chain management system over the internet may be encrypted to further secure the transmission of information.

S850a. the bank's e-commerce computer controls the loan approvals and the production lead time over the internet, accesses the financial interactive management system database 111 and updates the product tracking report over the internet.

In one embodiment the transmission of information in the supply chain management system over the internet may be encrypted to further secure the transmission of information.

S851a. the bank's e-commerce computer conducts regular fraud and default checking and control, accesses the financial interactive management system database 111 and updates the product tracking report over the internet;

In one embodiment the bank's e-commerce computer may be specially programmed using a set of algorithms and defined parameters to perform threshold screenings on a regular (e.g. daily) basis to detect any actual or potential fraud or default in the supply chain. In one embodiment the bank's e-commerce computer may use pre-set due dates as thresholds to carry out the regular fraud and default checking and control. The bank's e-commerce computer may use due dates including for example the dates of contracts, the dates of shipments, the dates of processing and operation in the supply chain, and the dates to make payments or repayments to the bank, to monitoring the supply chain and to determine any actual or potential fraud or default.

In one embodiment the transmission of information in the supply chain management system over the internet may be encrypted to further secure the transmission of information.

S852a. the bank's e-commerce computer conducts regular communications with suppliers, and alerts suppliers of an actual or potential fraud or default.

In one embodiment the communication with suppliers may use frequent emails or other electronic communications like a bulletin board system or a webpage, may use the applicant terminal devices as the receiver end, and may also use the mail system or couriers.

In one embodiment the bank's e-commerce computer may alert suppliers of an actual or potential fraud or default using the same methods in communicating with suppliers.

S860a. the bank's e-commerce computer monitors product delivery, and conducts product delivery control.

In one embodiment the bank's e-commerce computer may receive information from applicant terminal devices when suppliers ship the goods or products and input relevant carrier (e.g. UPS) and tracking information. The bank's e-commerce computer may subsequently access the carrier's database (e.g. UPS' shipment tracking system) to monitor the goods or products delivery.

In one embodiment the bank's e-commerce computer may conduct product delivery control by comparing past processing and delivery time information related to the suppliers, to the supply chain, and to the goods or products, and providing suppliers estimates on delivery time. The bank's e-commerce computer may track supplier's processing and shipping time and alert suppliers of approaching due dates in making deliveries.

Utilizing the supply chain management system 800 may reduce actual borrowings and may increase borrowing capacity of applicants 802 including SMEs (small and medium size enterprises) and most companies, because the supply chain management system 800 may increase product quality control in products supply chain. The supply chain management system 800 may also facilitate and speed up marketing and matching in consumer/industrial products supply chain when the central processing system of the supply chain manager 803 generates and updates the product tracking report, provides communications with and alerts to the applicants 802, controls loan approvals, lead time and delivery time, and conducts regular fraud and default and checking and control.

The financing interest charges in the supply chain management system 800 may be significantly lower than standard receivables financing's interest charges because the supply chain management system 800 may incorporate the loan approval system 200 herein described. The insurance premiums in the supply chain management system 800 may also be significantly lower than standard receivables insurance premiums because the supply chain management system 800 may also incorporate the insurance underwriting approval system 400 herein described. SMEs may enjoy lower total financing costs and insurance premiums using the supply chain management system 800.

On the other hand, the supply chain manager 801 e.g. the e-commerce provider or the bank's e-commerce department may charge service fees for providing related services in the supply chain management system 800, thus the supply chain management system 800 may provide incentives to banks or other e-commerce operators to engage in more supply chain transactions.

The supply chain management system 800 may be used for financing start-up companies, launching new products or brands of SMEs, or financing existing products or brands of most companies. By utilizing the supply chain management system 800, SMEs may be more confident in taking new business orders in a supply chain without worrying about finding additional working capital for the new business orders, because the utilizing of the loan approval system 200 and the insurance underwriting approval system 600 may reduce the SMEs' operating costs in a supply chain transaction. In addition, utilizing the supply chain management system 800 may help SMEs to identify good customers and reduce fraud or default in their daily business because the supply chain management system 800 conducts regular checking to identify actual or potential fraud or default.

1. A loan approval system for processing and loan approval requests and determining the outcome of the loan approval requests made by applicants in a supply chain based on their gross profit margins in the supply chain, comprising:
a central processing system configured to process the loan approval requests and to determine the outcome of the loan approval requests; and
data storage medium configured to store information input for the determination of the outcome of the loan approval requests,
wherein the central processing system is further configured:
to receive the information input for the determination of the outcome of the loan approval requests,
to process the information input for the determination of the outcome of the loan approval requests,
to store and access the information input for the determination of the outcome of the loan approval requests in the data storage media,
and
to determine the outcome of the loan approval requests based on the gross profit margins of the applicants.

2. The loan approval system in claim 1, wherein:
the central processing system is further configured to receive payment guarantees to secure loans for all the applicants.

3. The loan approval system in claim 1, wherein:
the outcome of the loan approval requests made by applicants in a supply chain is limited by the applicants' gross profit margins in the supply chain.

4. The loan approval system in claim 1, wherein:
the central processing system is a central computer of a financial institution.

5. The loan approval system in claim 1, wherein:
the data storage media is a database.

6. The loan approval system in claim 1, further comprising:
an applicant terminal device configured to input the information input for the determination of the outcome of the loan approval requests.

7. A insurance underwriting approval system for processing and insurance approval requests and determining the outcome of the insurance approval requests made by applicants in a supply chain based on their gross profit margins in the supply chain, comprising:
a central processing system configured to process the insurance approval requests and to determine the outcome of the insurance approval requests; and
data storage media configured to store the information input for the determination of the outcome of the insurance approval requests,
wherein the central processing system is further configured:
to receive information input for the determination of the outcome of the insurance approval requests,
to process the information input for the determination of the outcome of the insurance approval requests,
to store and access the information input for the determination of the outcome of the insurance approval requests in the database,
and
to determine the outcome of the loan approval requests based on the gross profit margins of the applicants.

8. The insurance underwriting approval system in claim 7, wherein:
the outcome of the insurance approval requests made by applicants in a supply chain is limited by the applicants' gross profit margins in the supply chain.

9. The insurance underwriting approval system in claim 7, wherein:
the central processing system is a central computer of an insurance provider.

10. The insurance underwriting approval system in claim 7, wherein:
the data storage media is a database.

11. The insurance underwriting approval system in claim 7, further comprising:
an applicant terminal device configured to input the information input for the determination of the outcome of the insurance approval requests.

12. A supply chain management system for managing supply chain business transactions, comprising:
a central processing system configured to manage the supply chain business transactions; and
data storage media configured to store information input relating to the supply chain business transactions,
wherein the central processing system is further configured:
to receive the information input relating to the supply chain business transactions,
to process the information input relating to the supply chain business transactions to store and access the information input relating to the supply chain business transactions,
and
to provide feedback according to the information input relating to the supply chain business transactions.

13. The supply chain management system in claim 12, wherein:
the central processing system is a central computer of a loan financial institution.

14. The supply chain management system in claim 12, wherein:
the central processing system is further configured to check and control actual or potential frauds or defaults in the supply chain business transactions.

15. A method for processing and loan approval requests and determining the outcome of the loan approval requests made by applicants in a supply chain based on their gross profit margins in the supply chain, comprising:
receiving information input for the determination of the outcome of the loan approval requests using a central processing system;
processing the information input for the determination of the outcome of the loan approval requests using the central processing system;
storing the information input for the determination of the outcome of the loan approval requests in data storage media using the central processing system;
accessing the information input for the determination of the outcome of the loan approval requests from the data storage media using the central processing system; and
determining the outcome of the loan approval requests based on the gross profit margins of the applicants using the central processing system.

16. The method in claim 15, further comprising:
receiving a guaranteed letter of credit to secure loans for all the applicants.

17. The method in claim 15, further comprising:
limiting the outcome of the loan approval requests made by applicants in a supply chain by the applicants' gross profit margins in the supply chain.

18. The method in claim 15, further comprising:
inputting the information input for the determination of the outcome of the loan approval requests using an applicant terminal device.

19. A method for processing and insurance approval requests and determining the outcome of the insurance approval requests made by applicants in a supply chain based on their gross profit margins in the supply chain, comprising:
receiving information input for the determination of the outcome of the insurance approval requests using a central processing system;
processing the information input for the determination of the outcome of the insurance approval requests using the central processing system;
storing the information input for the determination of the outcome of the insurance approval requests in data storage media using the central processing system;
accessing the information input for the determination of the outcome of the insurance approval requests from the data storage media using the central processing system; and
determining the outcome of the loan approval requests based on the gross profit margins of the applicants using the central processing system.

20. A method for managing supply chain business transactions, comprising:
receiving the information input relating to the supply chain business transactions using a central processing system;
processing the information input relating to the supply chain business transactions using the central processing system;
storing the information input relating to the supply chain business transactions in data storage media using the central processing system;
accessing the information input relating to the supply chain business transactions from the data storage media using the central processing system; and
providing feedback according to the information input relating to the supply chain business transactions using the central processing system.
